(19) United States
(12) Patent Application Publication
(10) Pub. No.: US 2008/0273595 A1
(43) Pub. Date: Nov. 6, 2008

(54) APPARATUS AND RELATED METHOD FOR PROCESSING MACROBLOCK UNITS BY UTILIZING BUFFER DEVICES HAVING DIFFERENT DATA ACCESSING SPEEDS

(76) Inventors: Yu-Wen Huang, Taipei City (TW); Chih-Hui Kuo, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/744,882

(22) Filed: May 6, 2007

(51) Int. Cl. H04B 1/66

(52) U.S. Cl. 375/240.12; 375/E07.026

(57) ABSTRACT

A method for processing a plurality of macroblock units in a video image is disclosed. The method includes: performing a specific video processing operation upon at least a first macroblock unit; storing information of the first macroblock unit in a first buffer device; storing the information of the first macroblock unit read from the first buffer device into a second buffer device, wherein a data accessing speed of the second buffer device is faster than a data accessing speed of the first buffer device; and performing the specific video processing operation upon a second macroblock unit in the plurality of macroblock units according to the information of the first macroblock unit stored in the second buffer device.

### BACKGROUND

The present invention relates to video processing, and more particularly, to video processing apparatuses and related methods for encoding or decoding macroblock units by processing multiple macroblock units in parallel.

The processing unit for video coding algorithms such as MPEG-1, MPEG-2, MPEG-4, H.263, H.264/AVC, SVC, H.265 is a macroblock unit, where each macroblock unit comprises at least one macroblock. For instance, in Macroblock Adaptive Frame/Field (MBAFF) coding, each macroblock unit includes a vertical adjacent macroblock-pair. However, in non-MBAFF coding, each macroblock unit includes only one macroblock. Information from upper macroblock units (i.e. a top-left macroblock unit, a top macroblock unit, and a top-right macroblock unit) and information from a left macroblock unit of a current macroblock unit are required when encoding/decoding the current macroblock unit. Many types of information (e.g. motion vectors, quantization parameters, Y/U/V total coefficients, etc. in H.264/AVC coding) from the upper macroblock units are required for coding the current macroblock. If the macroblock units are encoded/decoded in the order of raster scanning, it is necessary to buffer information of all macroblock units on the same row in a slice. This is because the information of the macroblock units on the same row is referenced when encoding/decoding the macroblock units on a next row in the same slice. The information of the macroblock units are typically buffered in a dynamic random access memory (DRAM). Furthermore, if the macroblock units are encoded/decoded in a flexible order instead of raster scanning, storing information of all macroblock units in the entire slice into the DRAM is necessary.

There exists a prior art scheme for storing information of the macroblock units into the DRAM. In non-MBAFF coding, information of all macroblock units is classified by different types of information (e.g. motion vectors or quantization parameters). Information of different macroblock units corresponding to the same type will be stored in a continuous address space in the DRAM. Similarly, in MBAFF coding, information of the macroblock units are still categorized by different types of information, and information of the top/bottom macroblocks in the macroblock units corresponding to the same type are also stored in a continuous address space in the DRAM respectively, causing the DRAM to be accessed discontinuously since different types of information of the macroblock units may be required when encoding/decoding a specific macroblock unit. The data access efficiency of the DRAM will be degraded due to discontinuous access.

Even though the process of encoding/decoding a macroblock unit can be divided into a plurality of pipelining stages to execute different processing operations (i.e. the pipelining stages can process different macroblock units simultaneously), the bandwidth of the DRAM may be still not enough if the DRAM is accessed discontinuously.

### SUMMARY

Therefore, one of the objectives of the present invention is to provide methods and related apparatuses for processing a plurality of macroblock units in a video image by accessing information of the macroblock units stored in a DRAM continuously and by utilizing a buffer device having a data accessing speed higher than that of the DRAM to store information of the macroblock units read from the DRAM, to solve the above-mentioned problems.

According to an embodiment of the present invention, a method for processing a plurality of macroblock units in a video image comprises: performing a specific video processing operation upon at least a first macroblock unit; storing information of the first macroblock unit in a first buffer device; storing the information of the first macroblock unit read from the first buffer device into a second buffer device, wherein a data accessing speed of the second buffer device is faster than a data accessing speed of the first buffer device; and performing the specific video processing operation upon a second macroblock unit according to the information of the first macroblock unit stored in the second buffer device.

According to another embodiment of the present invention, an apparatus for processing a plurality of macroblock units in a video image is disclosed. The apparatus comprises a video processing circuit, a first buffer device, and a second buffer device. The video processing circuit is utilized for performing a specific video processing operation upon at least a first macroblock unit. The first buffer device is coupled to the video processing circuit and utilized for storing information of the first macroblock unit. The second buffer device is coupled to the video processing circuit and the first buffer device, and is utilized for storing the information of the first macroblock unit read from the first buffer device. A data accessing speed of the second buffer device is faster than a data accessing speed of the first buffer device, and the video processing circuit performs the specific video processing operation upon a second macroblock unit according to the information of the first macroblock unit stored in the second buffer device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video processing apparatus according to a first embodiment of the present invention.

FIG. 2 is a diagram illustrating the process of encoding a plurality of macroblock units in a video image in the order of raster scanning.

FIG. 3 is a flowchart illustrating operation of the video processing apparatus shown in FIG. 1

FIG. 4 is a diagram of a video processing apparatus according to a second embodiment of the present invention.

FIG. 5 is a flowchart illustrating operation of an exemplary video processing apparatus.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

As mentioned above, for solving the problem caused by discontinuous DRAM accessing when encoding/decoding macroblock units, an order for storing information of the macroblock unit in the DRAM can be manipulated to allow continuous DRAM accessing. Since information of each macroblock unit is referenced by a bottom-left macroblock unit, a bottom macroblock unit, and a bottom-right macroblock unit, the information types are divided into three categories, called head information, body information, and tail information respectively. For a particular macroblock unit, all information including head, body, and tail information of the particular macroblock unit is required when processing the bottom macroblock unit, the head and tail information comprises required information for encoding/decoding the bottom-left and bottom-right macroblock units respectively. In other words, when encoding/decoding a specific macroblock unit, head information of a top-right macroblock unit of the specific macroblock unit, information of a top macroblock unit of the specific macroblock unit, and tail information of a top-left macroblock unit of the specific macroblock unit is referenced and is therefore stored in a continuous address space in the DRAM. However, the present invention is not limited to retrieving information of upper macroblock unit from the DRAM in a continuous manner, if the information is stored in discontinuous address space in the DRAM, the encoder/decoder takes more cycles to access required information from the DRAM. It should be noted that, in the following description, the video processing apparatuses are utilized for encoding macroblock units. However, similar principles can be implemented in video processing apparatuses for decoding macroblock units.

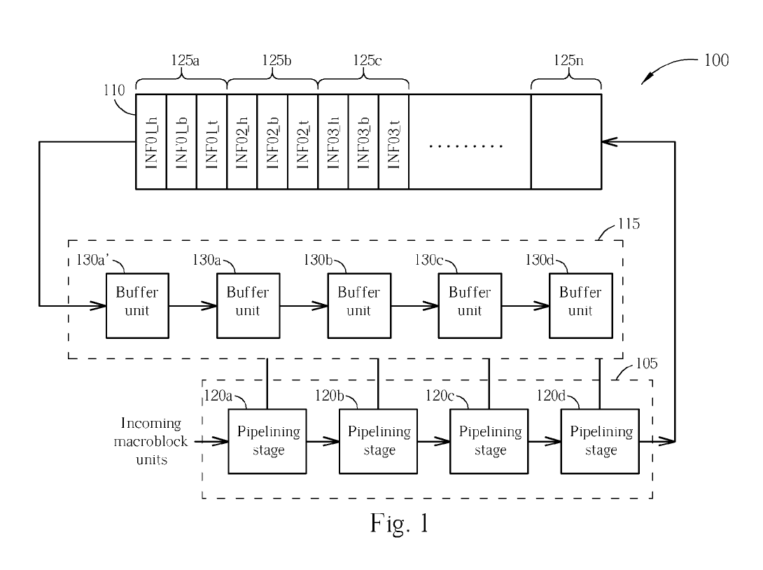

FIG. 1 is a block diagram of a video processing apparatus 100 according to a first embodiment of the present invention. As shown in FIG. 1, the video processing apparatus 100 comprises a video processing circuit 105, a first buffer device 110, and a second buffer device 115. It is assumed that macroblock units are encoded in an order of raster scanning, and the process of encoding each of the macroblock units is accomplished by pipelining stages 120a, 120b, 120c, and 120d included within the video processing circuit 105. Taking MPEG-2 or H.264/AVC for example, the process of encoding each of the macroblock units can be designed as four pipelining stages corresponding to, for example, integer motion estimation (IME), fractional motion estimation (FME), differential pulse code modulation (DPCM), and entropy coding (EC), respectively. In this embodiment, the pipelining stage 120a receives a specific macroblock unit in the incoming macroblock units to perform integer motion estimation, and the pipelining stage 120b performs fractional motion estimation on the specific macroblock unit after the pipelining stage 120a completes processing the specific macroblock unit and then starts processing a macroblock unit following the specific macroblock unit. Similarly, the pipelining stages 120c and 120d performs differential pulse code modulation and entropy coding respectively according to the above-mentioned way. Please note that the above-mentioned description is only utilized for illustrating the operation of the pipelining stages 120a, 120b, 120c, 120d, and is not intended to be a limitation of the present invention. For examples, the number of the pipelining stages is not limited to four.

The first buffer device 110 is usually implemented by the dynamic random access memory (DRAM) having a plurality of data storage sections 125a, 125b, 125c, . . . , 125n. In this embodiment, each of the data storage sections 125a, 125b, 125c, . . . , 125n is designed to be able to store information of a macroblock unit, and data capacities of the data storage sections 125a, 125b, 125c, . . . , 125n are identical. The second buffer device 115 comprises buffer units 130a′, 130a, 130b, 130c, and 130d arranged in a pipeline configuration. For example, when upper macroblock units are encoded by the pipelining stages 120a, 120b, 120c, and 120d, the information of the upper macroblock units is stored in the first buffer device 110, and a portion of the information required for encoding a current macroblock unit is preloaded to the buffer unit 130a′ before the pipelining stages 120a, 120b, 120c, 120d start processing (e.g., encoding) the current macroblock unit. Each time information stored in the first buffer device 110 is loaded into the leading buffer unit 130a′, data stored in the buffer unit 130a′ is shifted to the buffer unit 130a. Similarly, except for the data stored in the buffer unit 130d that will be discarded when data stored in the buffer unit 130c is shifted to the buffer unit 130d, each of the buffer units 130a, 130b, and 130c shifts data stored therein to a following buffer unit respectively before receiving data from a precedent buffer unit. The buffer units 130a′, 130a, 130b, 130c, and 130d are therefore arranged in the pipelining configuration.

Please note that the data accessing speed of the second buffer device 115 is typically higher than that of the first buffer device 110, and in some embodiments the buffer units of the second buffer device 115 are implemented by a plurality of registers. Data stored in registers can be easily accessed by each encoding pipelining stage, and it only takes one clock cycle to shift data from one buffer unit to another.

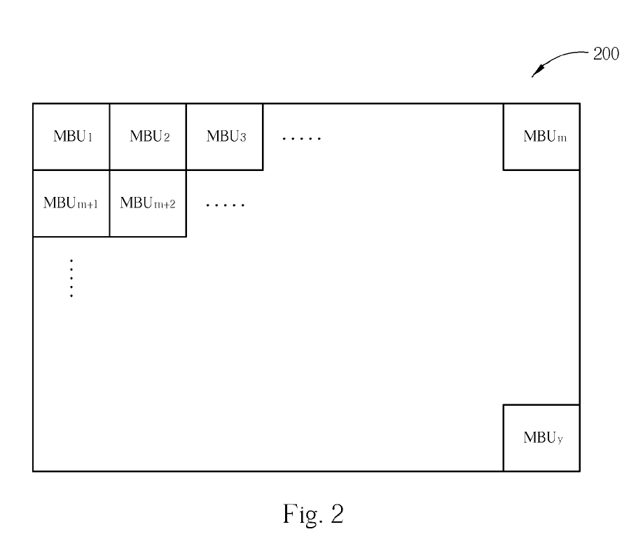

FIG. 2 is a diagram illustrating the process of encoding a plurality of macroblock units MBU₁, MBU₂, MBU₃, . . . , MBUₘ, MBUₘ₊₁, MBUₘ₊₂, MBU_{Y} in a video image 200 in the order of raster scanning. As shown in FIG. 2, the video processing apparatus encodes the macroblock unit MBU₁ first and proceeds to encode the macroblocks units MBU₂, MBU₃, . . . , MBU_{Y} until the last macroblock unit MBU_{Y}. When encoding macroblock units MBUₘ₊₁, MBUₘ₊₂, . . . , MBU_{Y}, information of their upper macroblock units is referenced. The data storage section 125a is utilized for storing head information INFO1_h, body information INFO1_b, and tail information INFO1_t of the macroblock unit MBU₁. Similarly, the data storage sections 125b and 125c are utilized for storing head information INFO2_h and INFO3_h, body information INFO2_b and INFO3_b, and tail information INFO2_t and INFO3_t of the macroblock units MBU₂ and MBU₃ respectively. Additionally, the buffer unit 130a′ is utilized for buffering (preloading) information of macroblock units in advance. For example, if the pipelining stage 120a starts to encode the macroblock unit MBUₘ and information of the macroblock unit MBUₘ₋₄ is stored into the first buffer device 110, information of the macroblock unit MBU₁ and head information of the macroblock unit MBU₂ is read from the first buffer device 110 and then loaded into the buffer unit 130a′. In other words, information INFO1_h-INFO2_h is continuously read from the first buffer device 110 and preloaded into the buffer unit 130a′. After the pipelining stage 120a completes encoding the macroblock unit MBUₘ, information INFO1_h-INFO1_t stored in the buffer unit 130a′ is delivered to the buffer unit 130a, and information INFO2_b, INFO2_t, and INFO3_h is read continuously from the first buffer device 110 into the buffer unit 130a′. The pipelining stage 120a can encode the macroblock unit MBUₘ₊₁ by referencing information INFO1_h, INFO1_b, INFO1_t, and INFO2_h buffered in the second buffer device 115 without referring to the first buffer device 110 (i.e. the DRAM). The performance of the video processing apparatus 100 is improved greatly by reducing the access time for fetching the upper macroblock information.

As mentioned above, after the pipelining stage 120a completes encoding the macroblock unit MBUₘ and before the pipelining stages 120a, 120b start to encode the MBUₘ₊₁, MBUₘ respectively, information INFO1_h, INFO1_b, INFO1_t of the macroblock unit MBU₁ is shifted from the buffer unit 130a to the buffer unit 130b, and information INFO2_h, INFO2_b, INFO2_t of the macroblock unit MBU₂ is shifted from the buffer unit 130a′ to the buffer unit 130a. The head Information INFO3_h of the macroblock unit MBU₃ is shifted to a tail area of the buffer unit 130a′, and body information INFO3_b and tail information INFO3_t of the macroblock unit MBU₃ and head information of the macroblock unit MBU₄ is read continuously from the first buffer device 110 into the buffer unit 130a′. The pipelining stage 120b can reference information INFO1_h, INFO1_b, INFO1_t stored in the buffer unit 130b and information INFO2_h stored in the buffer unit 130a to encode the macroblock unit MBUₘ; the pipelining stage 120a can also reference information INFO1_t stored in the buffer unit 130b, information INFO2_h, INFO2_b, INFO2_t stored in the buffer unit 130a, and information INFO3_h stored in the buffer unit 130a′ to encode the macroblock unit MBUₘ₊₁. In the same way, the other macroblock units can also be encoded stage by stage. In addition, in another embodiment, the buffer unit 130a′ can be removed from the second buffer device 115. In other words, the preloading function can be omitted. Although the pipelining stages 120a and 120b may need to refer to the first buffer device 110 when encoding the macroblock units. In some embodiments, the second buffer device 115 can be implemented by a plurality of static random access memories (SRAMs); in other words, the buffer units 130a′, 130a, 130b, 130c, 130d are implemented by SRAMs. The total area of the SRAMs is smaller than that of the registers even though the data accessing speed of a SRAM is slower than that of registers and accessing the SRAM may be more complex than accessing the registers. This alternative design also falls within the scope of the present invention.

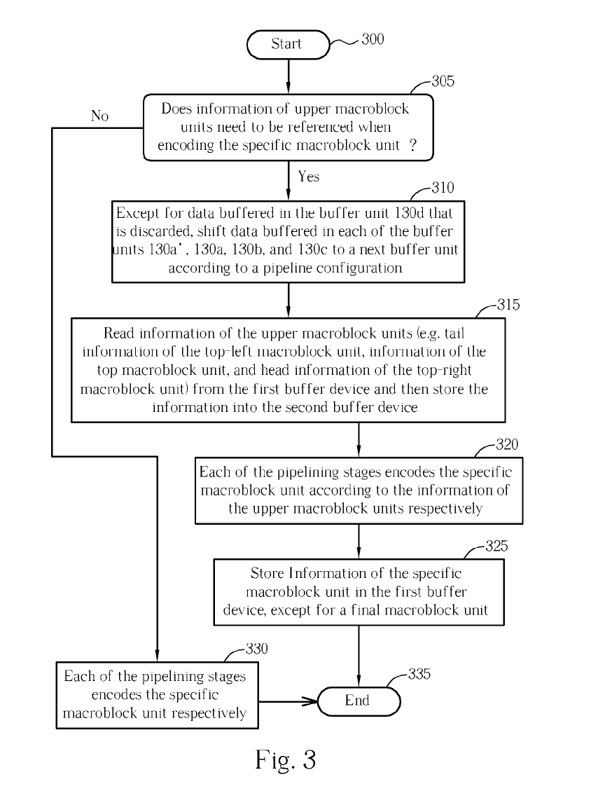

FIG. 3 is a flowchart illustrating operation of the video processing apparatus 100 shown in FIG. 1 when encoding a specific macroblock unit. Provided that substantially the same result is achieved, the steps of the flowchart shown in FIG. 3 need not be in the exact order shown and need not be contiguous, that is, other steps can be intermediate. The steps are shown as follows:
Step 300: Start.
Step 305: The video processing apparatus 100 checks if information of upper macroblock units needs to be referenced when encoding the specific macroblock unit. If information of upper macroblock units needs to be referenced, go to Step 310; otherwise, go to Step 330.
Step 310: Except for data buffered in the buffer unit 130d that is discarded, data buffered in each of the buffer units 130a′, 130a, 130b, and 130c is shifted to a next buffer unit according to a pipeline configuration.
Step 315: The information of the upper macroblock units (e.g. tail information of the top-left macroblock unit, information of the top macroblock unit, and head information of the top-right macroblock unit) is read from the first buffer device 110 and then stored into the second buffer device 115.
Step 320: Each of the pipelining stages 120a, 120b, 120c, and 120d encodes the specific macroblock unit according to the information of the upper macroblock units respectively.
Step 325: Information of the specific macroblock unit is stored in the first buffer device 110, except for a final macroblock unit.
Step 330: Each of the pipelining stages 120a, 120b, 120c, and 120d encodes the specific macroblock unit respectively.
Step 335: End.

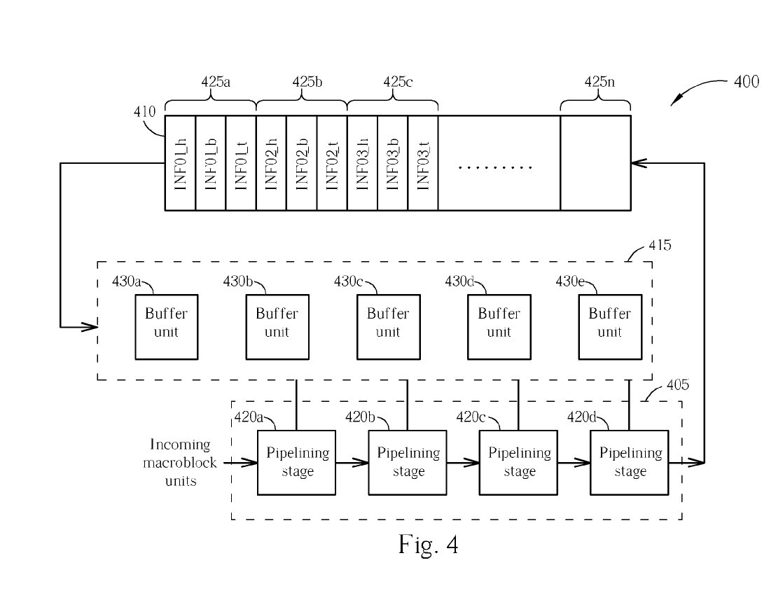

FIG. 4 is a diagram of a video processing apparatus 400 according to a second embodiment of the present invention. As shown in FIG. 4, the video processing apparatus 400 comprises a video processing circuit 405, a first buffer device 410, and a second buffer device 415. It is also assumed that the macroblock units are encoded in the order of raster scanning, and the process of encoding each of the macroblock units is accomplished by pipelining stages 420a, 420b, 420c, and 420d included within the video processing circuit 405. The operation and function of the pipelining stages 420a, 420b, 420c, and 420d is identical to that of the pipelining stages 120a, 120b, 120c, and 120d respectively; and is therefore not detailed here for brevity. The first buffer device 410 is implemented by a DRAM having a plurality of data storage sections 425a, 425b, 425c, . . . , 425n. Each of the data storage sections 425a, 425b, 425c, . . . , 425n is designed to be able to store information of a macroblock unit. The second buffer device 415 comprises a plurality of buffer units 430a, 430b, 430c, 430d, and 430e. In this embodiment, the buffer units 430a, 430b, 430c, 430d, and 430e are implemented by a plurality of SRAMs respectively.

In this embodiment, the operation of the video processing apparatus 400 is identical to that of the video processing apparatus 100 shown in FIG. 1 when encoding the macroblock units MBU₁-MBUₘ shown in FIG. 2 without having to reference information of the upper macroblock units. However, the operation of the second buffer device 415 is not identical to that of the second buffer device 115. Data stored in the first buffer device 410 is transmitted into the buffer units 430a, 430b, 430c, 430d, and 430e respectively without utilizing a pipeline configuration. For example, before encoding the macroblock units MBUₘ₊₁, MBUₘ₊₂, MBUₘ₊₃, MBUₘ₊₄, information of the macroblock units MBU₁, MBU₂, MBU₃, MBU₄, MBU₅ will be read continuously from the first buffer device 410 into the buffer units 430a, 430b, 430c, 430d, and 430e respectively. Therefore, each of the pipelining stages 420a, 420b, 420c, and 420d can encode the macroblock units MBU₁, MBU₂, MBU₃, MBU₄, MBU₅ respectively by referring to the second buffer device 415. Taking the pipelining stage 420a for example, the pipelining stage 420a encodes the macroblock unit MBUₘ₊₁ by referring to the buffer units 430a, 430b and proceeds to encoding the macroblock unit MBUₘ₊₂ by referring to the buffer units 430a, 430b, 430c. Continuously, the pipelining stage 420a encodes the macroblock unit MBUₘ₊₃ first by referring to the buffer units 430b, 430c, 430d and then encodes the macroblock unit MBUₘ₊₄ by referring to the buffer units 430c, 430d, 430e. It is not intended to be a limitation of the present invention, however. As mentioned above, information of the macroblock units MBU₁, MBU₂, MBU₃, MBU₄, MBU₅ can be also randomly stored into the buffer units 430a, 430b, 430c, 430d, and 430e only if each of the pipelining stages 420a, 420b, 420c, 420d can correctly refer to the buffer units 430a, 430b, 430c, 430d, and 430e. The operation of other pipelining stages 420b, 420c, and 420d for referring to the buffer units 430a, 430b, 430c, 430d, and 430e to encode a macroblock unit is similar to that of the pipelining stage 420a; further description is not detailed for brevity.

In other embodiments, each of the pipelining stages 420a, 420b, 420c, 420d further has a third buffer device, for example, on-chip registers. The third buffer device is utilized for buffering information fetched from at least one buffer unit in the second buffer device 415. Therefore, by fetching information required for encoding a specific macroblock unit in advance, each of the pipelining stages 420a, 420b, 420c, 420d can directly reference the fetched information buffered in the third buffer device. Additionally, the second buffer device can be implemented by a single SRAM; that is, the buffer units 430a, 430b, 430c, 430d, and 430e are meant to be a plurality of storage sections in one SRAM. This also falls within the scope of the present invention.

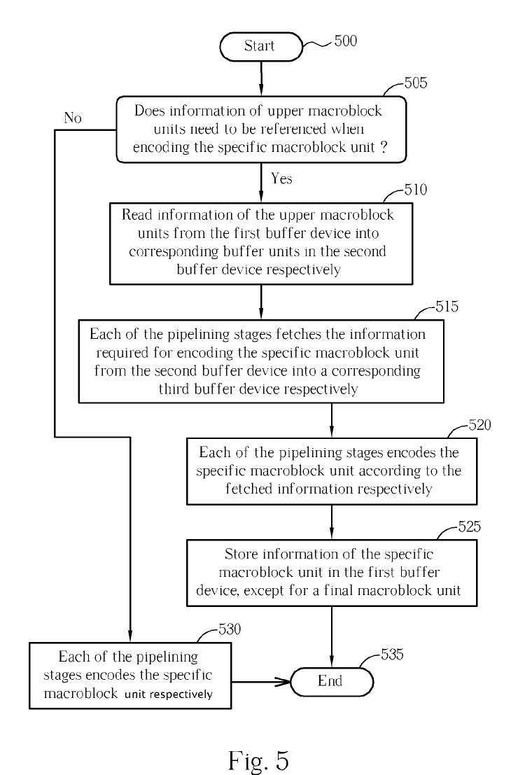

FIG. 5 is a flowchart illustrating operation of an exemplary video processing apparatus 400 shown in FIG. 4 when encoding a specific macroblock unit, where the pipelining stages 402a-402d comprise third buffer devices. Provided that substantially the same result is achieved, the steps of the flowchart shown in FIG. 5 need not be in the exact order shown and need not be contiguous, that is, other steps can be intermediate. The steps are shown as follows:
Step 500: Start.
Step 505: The video processing apparatus 400 checks if information of upper macroblock units needs to be referenced when encoding the specific macroblock unit. If information of upper macroblock units needs to be referenced, go to Step 510; otherwise, go to Step 530.
Step 510: Information of the upper macroblock units is read from the first buffer device 410 into corresponding buffer units in the second buffer device 415 respectively.
Step 515: Each of the pipelining stages 420a, 420b, 420c, and 420d fetches the information required for encoding the specific macroblock unit from the second buffer device 415 into a corresponding third buffer device respectively.
Step 520: Each of the pipelining stages 420a, 420b, 420c, and 420d encodes the specific macroblock unit according to the fetched information respectively.
Step 525: Information of the specific macroblock unit is stored in the first buffer device 410, except for a final macroblock unit.
Step 530: Each of the pipelining stages 420a, 420b, 420c, and 420d encodes the specific macroblock unit respectively.
Step 535: End.

In the above-mentioned embodiments, the specific video processing operation performed by the video processing apparatus is taken as an example illustrating encoding of the macroblock units; however, the specific video processing operation can be also a video decoding operation. The above-mentioned encoding operations (i.e. IME, FME, DPCM, EC) will be replaced by counterpart decoding operations. This also obeys the spirit of the present invention. Since a skilled person can readily appreciate the disclosed data buffering scheme applied to the macroblock unit decoding after reading above data buffering scheme applied to macroblock unit encoding, further description is omitted here for the sake of brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing a plurality of macroblock units in a video image, comprising:
(a) performing a specific video processing operation upon at least a first macroblock unit in the plurality of macroblock units;
(b) storing information of the first macroblock unit in a first buffer device;
(c) storing the information of the first macroblock unit read from the first buffer device into a second buffer device, wherein a data accessing speed of the second buffer device is faster than a data accessing speed of the first buffer device; and
(d) performing the specific video processing operation upon a second macroblock unit in the plurality of macroblock units according to the information of the first macroblock unit stored in the second buffer device.

2. The method of claim 1, wherein the specific video processing operation comprises a plurality of pipelining stages; the second buffer device comprises a plurality of buffer units arranged in a pipeline configuration.

3. The method of claim 2, wherein step (a) comprises performing the specific video processing operation upon a plurality of first macroblock units; step (b) comprises storing information of the first macroblock units in the first buffer device; step (c) comprises storing the information of the first macroblock units read from the first buffer device into a leading buffer unit of the second buffer device sequentially; step (d) comprises utilizing each of the pipelining stages to process the second macroblock unit, where each of the pipelining stages refers to information stored in at least one of the buffer units to process the second macroblock unit.

4. The method of claim 3, wherein a total number of the pipelining stages is smaller than a total number of the buffer units, and the leading buffer unit preloads information required by each of the pipelining stages when processing the second macroblock unit.

5. The method of claim 3, further comprising:
implementing the second buffer device by a plurality of registers or a plurality of SRAMs.

6. The method of claim 2, wherein a first buffer unit is accessed by a first pipelining stage and at least a second pipelining stage following the first pipelining stage when the first pipelining stage and the second pipelining stage process the second macroblock unit respectively; and step (d) further comprises:
after the first pipelining stage completes processing the second macroblock unit, delivering information stored in the first buffer unit to a second buffer unit following the first buffer unit excluding information not referenced by the second pipelining stage.

7. The method of claim 1, wherein step (b) comprises storing the information of the first macroblock unit in a continuous address space of the first buffer device.

8. The method of claim 1, wherein the specific video processing operation comprises a plurality of pipelining stages; the second buffer device comprises a plurality of buffer units.

9. The method of claim 8, wherein step (a) comprises performing the specific video processing operation upon a plurality of first macroblock units; step (b) comprises storing information of the first macroblock units in the first buffer device; step (c) comprises storing the information of the first macroblock units read from the first buffer device into buffer units respectively; step (d) comprises utilizing each of the pipelining stages to process the second macroblock unit, where each of the pipelining stages refers to information stored in at least one of the buffer units to process the second macroblock unit.

10. The method of claim 9, further comprising:
implementing the second buffer device by a plurality of SRAMs or a single SRAM.

11. The method of claim 9, further comprising:
providing at least one of the pipelining stages a third buffer device;
wherein step (d) further comprises fetching information required by the pipelining stage from at least one of the buffer units before the pipelining stage processes the second macroblock unit.

12. The method of claim 1, wherein the specific video processing operation is a video encoding operation or a video decoding operation.

13. An apparatus for processing a plurality of macroblock units in a video image, comprising:
a video processing circuit, for performing a specific video processing operation upon at least a first macroblock unit in the plurality of macroblock units;
a first buffer device, coupled to the video processing circuit, for storing information of the first macroblock unit; and
a second buffer device, coupled to the video processing circuit and the first buffer device, for storing the information of the first macroblock unit read from the first buffer device;
wherein a data accessing speed of the second buffer device is faster than a data accessing speed of the first buffer device; and the video processing circuit performs the specific video processing operation upon a second macroblock unit in the plurality of macroblock units according to the information of the first macroblock unit stored in the second buffer device.

14. The apparatus of claim 13, wherein the video processing circuit comprises:
a plurality of pipelining stages; and
the second buffer device comprises:
a plurality of buffer units arranged in a pipeline configuration;
wherein the video processing circuit performs the specific video processing operation upon a plurality of first macroblock units; the first buffer device is utilized for storing information of the first macroblock units; the second buffer device stores the information of the first macroblock units read from the first buffer device into a leading buffer unit of the second buffer device sequentially; and each of the pipelining stages refers to information stored in at least one of the buffer units to process the second macroblock unit.

15. The apparatus of claim 14, wherein a total number of the pipelining stages is smaller than a total number of the buffer units, and the leading buffer unit preloads information required by each of the pipelining stages when processing the second macroblock unit.

16. The apparatus of claim 15, wherein a first buffer unit of the second buffer device is accessed by a first pipelining stage and at least a second pipelining stage following the first pipelining stage when the first pipelining stage and the second pipelining stage process the second macroblock unit respectively; and after the first pipelining stage completes processing the second macroblock unit, the first buffer unit shifts data to a second buffer unit following the first buffer unit excluding information not referenced by the second pipelining stage.

17. The apparatus of claim 14, wherein the plurality of buffer units are implemented by a plurality of registers or a plurality of SRAMS.

18. The apparatus of claim 13, wherein the information of the first macroblock unit is stored in a continuous address space in the first buffer device.

19. The apparatus of claim 13, wherein the video processing circuit comprises:
a plurality of pipelining stages; and
the second buffer device comprises:
a plurality of buffer units;
wherein the video processing circuit is utilized for performing the specific video processing operation upon a plurality of first macroblock units; information of the first macroblock units is stored in the first buffer device; the information of the first macroblock units read from the first buffer device is stored into the buffer units respectively; and each of the pipelining stages refers to information stored in at least one of the buffer units to process the second macroblock unit.

20. The apparatus of claim 19, wherein the plurality of buffer units are implemented by a plurality of SRAMs or a single SRAM.

21. The apparatus of claim 19, wherein at least one of the pipelining stages has a third buffer device; and before the pipelining stage processes the second macroblock unit, information required by the pipelining stage is fetched from at least one of the buffer units into the third buffer device.

22. The apparatus of claim 13, wherein the specific video processing operation is a video encoding operation or video decoding operation.
